(19) United States
(12) Patent Application Publication
(10) Pub. No.: US 2010/0189999 A1
(43) Pub. Date: Jul. 29, 2010

(54) SURFACE PROTECTIVE FILM

(75) Inventors: Yoichiro Kimura, Chiba (JP); Tomoyuki Kitajima, Chiba (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: IDEMITSU UNITECH CO., LTD, Tokyo (JP)

(21) Appl. No.: 12/601,598

(22) PCT Filed: May 26, 2008
(86) PCT No.: PCT/JP2008/059662

§ 371 Date: Nov. 24, 2009

(30) Foreign Application Priority Data
May 31, 2007 (JP) 2007-144982

(51) Int. Cl. C09J 7/02; B32B 27/00; C09J 125/08; C09J 153/00

(52) U.S. Cl. 428/336; 428/355 BL

(57) ABSTRACT

A surface protective film includes a base material layer and an adhesive layer. The adhesive layer contains a styrene elastomer, a polyolefin and a tackifier. The styrene elastomer includes a hydrogenated or non-hydrogenated vinyl-polyisoprene block. The styrene elastomer contains 5% or more and 30% or less of styrene and 80% or more of triblock copolymer, and glass transition temperature of the styrene elastomer is −40 degrees C. or more and 20 degrees C. or less.

### TECHNICAL FIELD

The present invention relates to a surface protective film. Specifically, the present invention relates to a surface protective film suitable for protecting a surface of an adherend having an irregular surface such as a prism sheet.

### BACKGROUND ART

A surface protective film that is temporarily attached to a surface of a metal plate, a glass plate or a synthetic resin plate for preventing the surface from being damaged or being attached with dusts has been known (for instance, Patent Documents 1 to 3).

For instance, Patent Document 1 discloses a surface protective film including a polyolefin resin base material and an adhesive layer that contains a block copolymer represented by a general formula A-B-A (A is a styrene copolymer block and B is a copolymer block of ethylene and butylene) and a tackifier resin.

The surface protective film disclosed in Patent Document 1 can be laminated by co-extrusion and allow an adhesive to become solvent-free, so that the surface protective film is excellent in view of environmental protection and safe and sanitary conditions during manufacturing. Further, the surface protective film is economically favorable because its manufacturing process can be simplified.

Patent Document 1: JP-A-61-103975

Patent Document 2: Japanese Patent No. 2713519

Patent Document 3: JP-A-2000-80336

### DISCLOSURE OF THE INVENTION

### Problems to be Solved by the Invention

However, when a typical surface protective film as disclosed in Patent Document 1 is rolled up and stored or transferred as a roll, an adhesive layer wound around a rear surface of a base material may be firmly adhered to the base material.

Consequently, the surface protective film is not easily wound off from the roll, thereby reducing efficiency of operation for attaching to a surface of an adherend. When the surface protective film is forced to be wound off, the base material may be partially stretched and deformed or the adhesive layer may be partially peeled off, so that the surface protective film may not function.

To solve these problems, a mold releasing agent is coated or mold releasing treatment such as corona treatment is applied on the rear surface of the base material.

However, when a mold releasing agent is used, a particular kind of mold releasing agent that is firmly adhered to the base material and is not adhered to the adhesive layer is required. In addition, when the mold releasing agent seeps into the adhesive layer, adhesive force of the surface protective film for the adherend may be reduced.

Further, due to complicated process for mold releasing agent coating or mold releasing treatment such as corona treatment, manufacturing cost of the surface protective film may be increased.

An object of the invention is to solve the above-described problems and to provide a surface protective film that is favorably wound off from a roll, in which a mold releasing treatment to a base material layer is not required.

### Means for Solving the Problems

A surface protective film according to an aspect of the invention comprises: a base material layer and an adhesion layer, where the adhesion layer comprises a styrene elastomer, a polyolefin and a tackifier, and the styrene elastomer includes a non-hydrogenated or hydrogenated vinyl-polyisoprene block.

The adhesion layer contains a styrene elastomer including a non-hydrogenated or hydrogenated vinyl-polyisoprene block according to the aspect of the invention. Accordingly, when the surface protective film is rolled up as a roll, the surface protective film can be easily wound off from the roll without applying a mold releasing treatment to the base material layer.

Thus, efficiency of operation for attaching the surface protective film to the surface of an adherend can be enhanced. Further, it is less likely that the base material layer is partially stretched and deformed or the adhesion layer is partially peeled to spoil the surface protective film. Further, since a mold releasing treatment for obtaining unwinding property from the roll is not required, manufacturing cost of the surface protective film can be reduced.

Also, since the adhesion layer contains a polyolefin and tackifier, the adhesion strength to the adherend can be adjusted in a proper range so that the surface protective film functions.

As the base material layer of the surface protective film according to the aspect of the invention, polyolefin materials or the like can be used.

Additives such as a pigment, an antioxidant, a stabilizer and an ultraviolet absorber may be added as needed.

The base material layer may be formed by a plurality of layers. The total thickness of the base material layer formed by a single layer or a plurality of layers is favorably 30 μm or more and 80 μm or less.

When the thickness of the base material layer is less than 30 μm, its rigidity is reduced. Thus, the operability when the surface protective film is attached to or peeled off from the adherend is deteriorated, and the surface protective film is stretched when being wound off from the roll. When the thickness of the base material layer is more than 80 μm, the rigidity is too increased and thus the operability when the surface protective film is attached to and peeled off from the adherend is deteriorated.

The styrene elastomer included in the adhesion layer is a block copolymer represented by a general formula (1) or general formula (2).

[Chemical Formula 1]

A-B A (1)

A-B (2)

In the general formulae (1) and (2), A is a styrene block and B is a non-hydrogenated vinyl-polyisoprene block or hydrogenated vinyl-polyisoprene block represented by a general formula (3) as follows. The styrene elastomer includes an uncoupled styrene block and an uncoupled hydrogenated or non-hydrogenated vinyl-polyisoprene block.

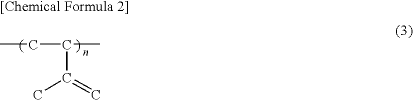

Examples of a polyolefin used for the adhesion layer include low-density polyethylene, medium-density polyethylene, high-density polyethylene, linear low-density polyethylene, ethylene-α-olefin copolymer, ethylene-vinyl-acetate copolymer, ethylene-ethylacrylate copolymer, ethylene-methyl methacrylate copolymer, ethylene-n-butyl acrylate copolymer, and polypropylene (homopolymer, random copolymer, block copolymer).

As a tackifier used for the adhesion layer, resin selectively compatible with a hydrogenated or non-hydrogenated vinyl-polyisoprene block of a styrene elastomer (i.e., B in the general formulae (1) and (2)) can be used.

Such resin may be aliphatic hydrocarbon resin, terpene resin, coumarone-indene resin, aromatic hydrocarbon resin or rosin resin.

Additives such as a softener (e.g. liquid polymer and paraffin oil), a filler, a pigment, an antioxidant, a stabilizer and an ultraviolet absorber may be added to the adhesion layer as needed,

Patent Document 3 discloses a surface protective film in which an adhesive layer contains a styrene elastomer including a block derived from isoprene. While a styrene elastomer including a simple polyisoprene block is used in the surface protective film disclosed in Patent Document 3, a styrene elastomer including a non-hydrogenated or hydrogenated vinyl-polyisoprene block is used in the surface protective film according to the aspect of the invention.

In other words, in the surface protective film according to the aspect of the invention, the adhesion layer contains a non-hydrogenated vinyl-polyisoprene block or hydrogenated vinyl-polyisoprene block represented by the above general formula (3), thereby enhancing unwinding property of the surface protective film from the roll.

On the other hand, the surface protective film disclosed in Patent Document 3 in which the adhesive layer contains a styrene elastomer containing a simple polyisoprene block has high adhesion strength between the adhesive layer and the base material, so that the surface protective film is not easily wound off from the roll.

In the above aspect of the invention, the adhesion layer preferably comprises: 10 parts by weight or more and 200 parts by weight or less of the polyolefin; and 3 parts by weight or more and 100 parts by weight or less of the tackifier relative to 100 parts by weight of the styrene elastomer.

According to the above arrangement, the adhesion strength of the adhesion layer to the adherend can be adjusted in a proper range so that the surface protective film functions.

When the polyolefin content is less than 10 parts by weight, the adhesion strength to the adherend is too high and thus adhesive deposits may be left after peeling. Also, the adhesion strength to the rear surface of the base material layer is increased, so that unwinding property from the roll may be reduced. When the polyolefin content is more than 200 parts by weight, the adhesion strength is decreased and the surface protective film may be peeled off from the surface of the adherend. Specifically, the surface protective film is easily peeled off from an adherend having an irregular surface such as a prism sheet.

The content of the polyolefin is preferably in the range of 15 to 100 parts by weight, more preferably in the range of 20 to 60 parts by weight.

When the tackifier content is less than 3 parts by weight, the adhesion strength is decreased and thus the surface protective film may be peeled off from the surface of the adherend. Specifically, the surface protective film is easily peeled off from an adherend having an irregular surface such as a prism sheet. When the tackifier content is more than 100 parts by weight, the adherend may be contaminated by bleed or cohesion force may be reduced.

The tackifier content is preferably in the range of 5 to 50 parts by weight.

In the above aspect of the invention, the styrene elastomer preferably contains 5% or more and 30% or less of styrene and 80% or more of triblock copolymer, glass transition temperature of the styrene elastomer being −40 degrees C. or more and 20 degrees C. or less.

According to the above arrangement, favorable unwinding property of the surface protective film from the roll can be ensured while adhesion strength of the adhesion layer to the adherend can be adjusted in a proper range so that the surface protective film functions.

When the styrene content is less than 5%, hardness is low and adhesion strength is too high. Thus, adhesive deposits may be caused from the adherend during peeling. Specifically, adhesive deposits are easily caused from an adherend having an irregular surface such as a prism sheet. When the styrene content is more than 30%, the hardness is too high and the adhesion strength to the adhrerend is weak. Thus, the surface protective film may be peeled off. Specifically, the surface protective film is easily peeled off from an adherend having an irregular surface such as a prism sheet.

The styrene content is preferably in the range of 10 to 25%.

When the triblock copolymer content is less than 80%, the adhesion strength to the adherend is too high and thus adhesive deposits may be left after peeling. Also, since the adhesion strength to the rear surface of the base material layer is increased, unwinding property from the roll may be reduced.

When the glass transition temperature of the styrene elastomer is less than −40 degrees C., adhesion strength in a typical usable temperature area (for instance, −20 to 40 degrees C.) of the surface protective film is not easily obtained and thus the surface protective film may be peeled off from the adherend. Specifically, the surface protective film is easily peeled off from an adherend having an irregular surface such as a prism sheet.

In the above aspect of the invention, the thickness of the adhesion layer is preferably 5 μm or more and 25 μm or less.

According to the above arrangement, the surface of an adherend having an irregular surface such as a prism sheet can be favorably protected.

When the thickness of the adhesion layer is less than 5 μm, ends of projected parts of an adherend having an irregular surface may be damaged. Also, the adhesion strength may be reduced and thus the surface protective film may be peeled off from the adherend. When the thickness of the adhesion layer is more than 25 μm, the adhesion strength is too high and thus adhesive deposits may be left when the surface protective film is peeled from the adherend. Also, since the adhesion strength to the rear surface of the base material layer is increased, unwinding property from the roll may be reduced.

The thickness of the adhesion layer is preferably in the range of 10 to 20 μm.

In the above aspect of the invention, the base material layer and the adhesion layer are preferably laminated by co-extrusion.

According to the above arrangement, the base material layer and the adhesion layer can be laminated without employing a solvent at the same time, thus producing a surface protective film by a relatively simple manufacturing device. Also, due to a simplified manufacturing process, manufacturing cost of the surface protective film can be reduced to a moderate price. Further, in a surface protective film manufactured by a co-extrusion, interlaminar strength of a surface of the base material layer and the adhesion layer is high and the possibility that adhesive deposits are left after peeling from the adherend is reduced.

### BEST MODE FOR CARRYING OUT THE INVENTION

An exemplary embodiment of the invention will be described below.

A surface protective film of the exemplary embodiment includes a base material layer and an adhesion layer.

The base material layer is not particularly limited as long as it is a sheet or film that is commonly used as a support of a surface protective film, examples of which include a film produced by polyolefin materials or the like.

Examples of polyolefin used for the base material layer include low-density polyethylene, medium-density polyethylene, high-density polyethylene, linear low-density polyethylene, ethylene-α-olefin copolymer, ethylene-vinyl-acetate copolymer, ethylene-ethylacrylate copolymer, ethylene-methyl methacrylate copolymer, ethylene-n-butyl acrylate copolymer, and polypropylene (homopolymer, random copolymer, block copolymer). The resins as described above may be used alone or in combination. Especially, polypropylene of a block copolymer (BPP) is favorable as a material for the base material layer. The surface of the base material layer is roughened by using BPP and thus unwinding property is further enhanced while tearing strength and impact strength are also enhanced. Further, heat resistance and rigidity can be added.

Additives such as a pigment, an antioxidant, a stabilizer and an ultraviolet absorber may be added to the base material layer as needed.

The base material layer may be formed by a plurality of layers. The total thickness of the base material layer formed by a single layer or a plurality of layers is favorably 30 μm or more and 80 μm or less.

The adhesion layer contains styrene elastomer, polyolefin and tackifier.

The styrene elastomer included in the adhesion layer is a block copolymer represented by the above general formula (1) or general formula (2).

In the general formulae (1) and (2), A is a styrene block and B is a non-hydrogenated vinyl-polyisoprene block or hydrogenated vinyl-polyisoprene block represented by the above general formula (3). The styrene elastomer includes an uncoupled styrene block and an uncoupled hydrogenated or non-hydrogenated vinyl-polyisoprene block.

In the styrene elastomer, styrene content is 5% or more and 30% or less, triblock copolymer content is 80% or more, and glass transition temperature is −40° C. or more and 20° C. or less.

The styrene content is preferably 10% or more and 25% or less.

Here, the styrene content means styrene block content relative to a total amount of styrene elastomer.

The styrene content is calculated by, for instance, the following method.

The styrene elastomer is dissolved in a small amount of hexane and then excess of acetone is added, so that the styrene elastomer is separated into acetone-insoluble components and acetone-soluble components. The insoluble components are measured by an NMR (nuclear magnetic resonance spectrum method) so as to calculate a styrene content from an integral intensity ratio of spectrum.

The triblock copolymer is a block copolymer represented by the above general formula (1).

The triblock copolymer content is calculated by, for instance, the following method.

The styrene elastomer is dissolved in tetrahydrofuran (TFH). Two columns for liquid chromatography of GS5000H and two columns for liquid chromatography of G4000H (four columns in total) manufactured by Tosoh Corporation are connected in series. High-performance liquid chromatography is performed at temperature of 40 degrees C. and flow rate of 1 ml/min by using THF for a mobile phase. From the obtained chart, a coupling component, i.e., a peak area corresponding to a triblock copolymer, is obtained. A percentage of the peak area relative to an entire peak area is the triblock copolymer content.

The glass transition temperature is calculated by, for instance, the following method.

The styrene elastomer is dissolved in a small amount of hexane and then excess of acetone is added, so that the styrene elastomer is separated into acetone-insoluble components and acetone-soluble components. The temperature of the insoluble components is raised from a room temperature at a ratio of 20° C./min using a differential scanning calorimeter, and calorific value is measured to depict an endothermic curved line. Two extended lines are added to the endothermic curved line. Then, the glass transition temperature is obtained from an intersection point of a half straight line between the extended lines and the endothermic curved line.

Examples of polyolefin used for the adhesion layer include low-density polyethylene, medium-density polyethylene, high-density polyethylene, linear low-density polyethylene, ethylene-α-olefin copolymer, ethylene-vinyl-acetate copolymer, ethylene-ethylacrylate copolymer, ethylene-methyl methacrylate copolymer, ethylene-n-butyl acrylate copolymer, and polypropylene (homopolymer, random copolymer, block copolymer). Among the above-described polyolefin, polypropylene is preferable as a material for the adhesion layer. Polypropylene is compatible with styrene elastomer including a non-hydrogenated or hydrogenated vinyl-polyisoprene block and has excellent heat resistance. In addition, polypropylene does not easily cause an adherend to be contaminated by bleed.

As a tackifier used for the adhesion layer, resin selectively compatible with a hydrogenated or non-hydrogenated vinyl-polyisoprene block of styrene elastomer can be used.

Such resin may be aliphatic hydrocarbon resin, terpene resin, coumarone-indene resin, aromatic hydrocarbon resin or rosin resin.

Additives such as a softener (e.g. liquid polymer and paraffin oil), a filler, a pigment, an antioxidant, a stabilizer and an ultraviolet absorber may be added to the adhesion layer as needed.

The adhesion layer contains 10 parts by weight or more and 200 parts by weight or less of the polyolefin and 3 parts by weight or more and 100 parts by weight or less of the tackifier relative to 100 parts by weight of the styrene elastomer.

The content of the polyolefin is preferably in the range of 15 to 100 parts by weight, more preferably in the range of 20 to 60 parts by weight. The content of the tackifier is preferably in the range of 5 to 50 parts by weight.

The thickness of the adhesion layer is in the range of 5 to 25 μm, preferably in the range of 10 to 20 μm.

In the exemplary embodiment, the base material layer and adhesion layer are laminated by co-extrusion.

### ADVANTAGES OF EXEMPLARY EMBODIMENT

According to the above-described exemplary embodiment, the following advantages can be attained.

The adhesion layer contains a styrene elastomer including a non-hydrogenated or hydrogenated vinyl-polyisoprene block according to the exemplary embodiment. Accordingly, when a surface protective film is rolled up as a roll, the surface protective film can be easily wound off from the roll without applying a mold releasing treatment to the base material layer.

Thus, efficiency of operation for attaching the surface protective film to the surface of an adherend can be enhanced. Also, it is less likely that the base material layer is partially stretched and deformed or the adhesion layer is partially peeled to spoil the surface protective film. Further, since a mold releasing treatment for obtaining unwinding property from the roll is not required, manufacturing cost of the surface protective film can be reduced.

Since the adhesion layer contains a predetermined amount of polyolefin and tackifier while the styrene content is in the range of 5 to 30%, the triblock copolymer content is 80% or more and the glass transition temperature is in the range of −40 to 20 degrees C. in the styrene elastomer, adhesion strength of the adhesion layer to the adherend can be adjusted in a proper range as the surface protective film and favorable unwinding property from the roll of the surface protective film can be ensured.

Since problems such as peeling and adhesive deposits are not easily occurred, the surface protective film can be favorably used for an adherend having an irregular surface such as a prism sheet.

Since the thickness of the adhesion layer is in the range of 5 to 25 μm, the surface of an adherend having an irregular surface such as a prism sheet can be favorably protected.

In other words, it is less likely that projected parts on the surface are damaged when the adhesion layer is too thin, adhesive deposits are left after peeling when the adhesion layer is too thick, or unwinding property from the roll is reduced.

Since the base material layer and the adhesion layer are laminated by co-extrusion, the base material layer and the adhesion layer can be laminated without requiring a solvent at the same time, thus producing a surface protective film by a relatively simple manufacturing device. Also, due to a simplified manufacturing process, manufacturing cost of the surface protective film can be reduced to a moderate level. Further, in a surface protective film manufactured by co-extrusion, interlaminar strength of a surface of the base material layer and the adhesion layer is high. In addition, such surface protective film hardly leave adhesive deposits when being peeled off from the adherend.

### MODIFICATIONS

The invention is not limited to the above-described embodiment but also includes modifications and improvements as long as an object of the invention can be achieved.

Although the surface protective film exemplarily includes the base material layer and the adhesion layer in the exemplary embodiment, the surface protective film may include other functional layers such as an ultraviolet absorbing layer. In this instance, a surface of an adherend can be protected not only from physical contact but also from other factors such as ultraviolet rays.

The specific material, arrangement and the like described in carrying out the invention can be altered as long as an object of the invention can be achieved.

### EXAMPLES

The invention will further be described below with reference to Examples and Comparatives. Note that the invention is not limited to Examples.

### Example 1

100 parts by weight of a styrene elastomer (manufactured by KURARAY CO., LTD., brand name: HYBRAR 7125) including a vinyl-polyisoprene block in which styrene content was 20%, triblock copolymer content was 100% and glass transition temperature was −15 degrees C., 35 parts by weight of RPP (manufactured by Japan Polypropylene Corporation, brand name: WINTEC WFW-4) as polyolefin, and 16 parts by weight of a tackifier (manufactured by Idemitsu Kosan Co., Ltd., brand name: I-MARV P-140) were mixed to be used as a material for the adhesion layer.

By co-extruding the material for the adhesion layer and BPP (manufactured by SunAllomer Ltd., brand name: PC-684S) used as a material for the base material layer so that the adhesion layer had 11 μm thickness and the base material layer had 39 μm thickness, a surface protective film was obtained.

### Example 2

Except that 38 parts by weight of a polyolefin and 9 parts by weight of a tackifier were mixed, a surface protective film was obtained in the same manner as in Example 1.

### Example 3

Except that a styrene elastomer (manufactured by KURARAY CO., LTD., brand name: HYBRAR 7311) including a vinyl-polyisoprene block in which styrene content was 13%, triblock copolymer content was 100% and glass transition temperature was −32 degrees C. was alternatively used, a surface protective film was obtained in the same manner as in Example 1.

### Example 4

Except that a styrene elastomer (manufactured by KURARAY CO., LTD., brand name: HYBRAR 5125) including a vinyl-polyisoprene block in which styrene content was 20%, triblock copolymer content was 100% and glass transition temperature was −13 degrees C. was alternatively used, a surface protective film was obtained in the same manner as in Example 1.

### Example 5

Except that a styrene elastomer (manufactured by KURARAY CO., LTD., brand name: HYBRAR 5127) including a vinyl-polyisoprene block in which styrene content was 20%, triblock copolymer content was 100% and glass transition temperature was 8 degrees C. was alternatively used, a surface protective film was obtained in the same manner as in Example 1.

### Comparison 1

Except that a styrene elastomer (manufactured by KURARAY CO., LTD., brand name: SEPTON 2004) that did not includes a vinyl-polyisoprene block in which styrene content was 18%, triblock copolymer content was 100% and glass transition temperature was −55 degrees C. was alternatively used, a surface protective film was obtained in the same manner as in Example 1.

### Comparison 2

Except that a styrene elastomer (manufactured by ASAHI KASEI CO., LTD., brand name: Tuftec H1052) that did not include a vinyl-polyisoprene block in which styrene content was 20%, triblock copolymer content was 100% and glass transition temperature was −85 degrees C. was alternatively used, a surface protective film was obtained in the same manner as in Example 1.

### Comparison 3

100 parts by weight of a styrene elastomer (manufactured by KURARAY CO., LTD., brand name: HYBRAR) including a vinyl-polyisoprene block in which styrene content was 13%, triblock copolymer content was 100%, glass transition temperature was −15 degrees C., and 16 parts by weight of a tackifier (manufactured by Idemitsu Kosan Co., Ltd., brand name: I-MARV P-140) were mixed to be used as a material for the adhesion layer.

By co-extruding the material for the adhesion layer and BPP (manufactured by SunAllomer Ltd., brand name: PC-684S) used as a material for the base material layer so that the adhesion layer had 11 μm thickness and the base material layer had 39 μm thickness, a surface protective film was obtained.

### Evaluation Method

### (1) Adhesion Strength

The surface protective films according to Examples 1 to 5 and Comparatives 1 to 3 were attached to an acrylic resin prism sheet having a cross-sectional triangle-shape having approximately apex angle of 90 degrees C. and height of 30 μm, and then initial adhesion strength and longitudinal adhesion strength after warming were measured.

### (1.1) Initial Adhesion Strength

Each surface protective film was attached to an adherend (prism sheet) under linear pressure of 0.38 MPa at 2 m/min and stored at 23 degrees C. for 24 hours.

Then, the surface protective film was peeled off at a tensile speed of 0.3/min and 180 degrees peel using a tensile testing machine, and then a resistance was measured.

The case where the measured resistance was in the range of 0.03 N/25 mm to 0.15 N/25 mm was represented by A, and the case where the measured resistance was out of the range of 0.03 N/25 mm to 0.15 N/25 mm was represented by B.

### (1.2) Longitudinal Adhesion Strength

Each surface protective film was attached to an adherend (prism sheet) under linear pressure of 0.38 MPa at 2 m/min and stored at 50 degrees C. for 1 week.

Then, the surface protective film was peeled off at a tensile speed of 0.3/min and 180 degrees peel using a tensile testing machine, and then a resistance was measured.

The case where the measured resistance was in the range of 0.03 N/25 mm to 0.15 N/25 mm was represented by A, and the case where the measured resistance was out of the range of 0.03 N/25 mm to 0.15 N/25 mm was represented by B.

### (2) Unwinding Strength

An adhesion surface of the surface protective film was attached to a rear surface of the base material layer under linear pressure of 0.38 MPa at 2 m/min, and stored at 23 degrees C. for 5 minutes.

Then, the surface protective film was peeled off at a tensile speed of 0.3/min and 90 degrees peel using a tensile testing machine, and then a resistance was measured.

The case where the measured resistance was 0.5 N/25 mm or less was represented by A, and the case where the measured resistance was more than 0.5 N/25 mm was represented by B.

### (3) Adhesive Deposit

The surface protective film was attached to an adherend (prism sheet) under linear pressure of 0.38 MPa at 2 m/min and stored at 50 degrees C. for 1 week.

Then, the surface protective film was peeled off and the adherend was visually observed. The case where adhesive deposits were observed was represented by B, and the case where any adhesive deposits were not observed was represented by A.

The evaluation results are shown in Table 1.

TABLE 1

| | | | Exam- | Exam- | Exam- | Exam- | Exam- | Compar- | Compar- | Compar- |
|---|---|---|---|---|---|---|---|---|---|---|
| | | | ple 1 | ple 2 | ple 3 | ple 4 | ple 5 | ative 1 | ative 2 | ative 3 |
| composition of | styrene | styrene content (%) | 20 | 20 | 13 | 20 | 20 | 18 | 20 | 13 |
| adhesion layer | elastomer | triblock copolymer content (%) | 100 | 100 | 100 | 100 | 100 | 100 | 100 | 100 |
| | | existence or nonexistence of vinyl- | present | present | present | present | present | not | not | present |
| | | polyisoprene block | | | | | | present | present | |
| | | glass transition temperature (° C.) | −15 | −15 | −32 | −13 | 8 | −55 | −85 | −32 |
| | | hardness | 64 | 64 | 41 | 60 | 84 | 67 | 67 | 41 |
| | | mixed amount (parts by weight) | 100 | 100 | 100 | 100 | 100 | 100 | 100 | 100 |

| | | | | | | | | |
|---|---|---|---|---|---|---|---|---|
| mixed amount of polyolefin (parts by weight) | 35 | 38 | 35 | 35 | 35 | 35 | 35 | 0 |
| mixed amount of tackifier (parts by weight) | 16 | 9 | 16 | 16 | 16 | 16 | 16 | 16 |
| base material layer | BPP | BPP | BPP | BPP | BPP | BPP | BPP | BPP |
| thickness of adhesion layer (μm) | 11 | 11 | 11 | 11 | 11 | 11 | 11 | 11 |
| initial adhesion strength (N/25 mm) | 0.05 A | 0.03 A | 0.04 A | 0.08 A | 0.03 A | 0 B | 0.02 B | 0.24 B |
| longitudinal adhesion strength (N/25 mm) | 0.05 A | 0.03 A | 0.03 A | 0.08 A | 0.04 A | 0 B | 0.02 B | 0.05 A |
| unwinding strength (N/25 mm) | 0.04 A | 0.02 A | 0.12 A | 0.22 A | 0.03 A | 0.12 A | 0.12 A | 1.17 B |
| adhesive deposit | A | A | A | A | A | A | A | A |

As obvious from the table 1, the surface protective films according to Examples 1 to 5 that had an arrangement according to an aspect of the invention exhibited favorable adhesion strength and unwinding strength. The adhesion strength and unwinding strength were stably maintained for a long time.

On the other hand, the surface protective films according to Comparatives 1 and 2 in which the adhesion layer contained a styrene elastomer that did not include a vinyl-polyisoprene had weak initial and longitudinal adhesion strength.

The surface protective film according to Comparative 3 in which the adhesion layer did not contain polyolefin had deteriorated unwinding property and high initial adhesion strength.

### INDUSTRIAL APPLICABILITY

The invention is applicable as a surface protective film favorable for protecting a surface of an adherend having an irregular surface such as a prism sheet.

1. A surface protective film, comprising: a base material layer and an adhesion layer, wherein
the adhesion layer comprises:
a styrene elastomer;
a polyolefin; and
a tackifier, and
the styrene elastomer includes a non-hydrogenated or hydrogenated vinyl-polyisoprene block.

2. The surface protective film according to claim 1, wherein the adhesion layer comprises: 10 parts by weight or more and 200 parts by weight or less of the polyolefin; and 3 parts by weight or more and 100 parts by weight or less of the tackifier relative to 100 parts by weight of the styrene elastomer.

3. The surface protective film according to claim 1, wherein the styrene elastomer contains 5% or more and 30% or less of styrene and 80% or more of triblock copolymer, glass transition temperature of the styrene elastomer being −40 degrees C. or more and 20 degrees C. or less.

4. The surface protective film according to claim 1, wherein, the thickness of the adhesion layer is 5 μm or more and 25 μm or less.

5. The surface protective film according to claim 1, wherein, the base material layer and the adhesion layer are laminated by co-extrusion.

6. The surface protective film according to claim 2, wherein, the thickness of the adhesion layer is 5 μm or more and 25 μm or less.

7. The surface protective film according to claim 3, wherein, the thickness of the adhesion layer is 5 μm or more and 25 μm or less.

8. The surface protective film according to claim 2, wherein, the base material layer and the adhesion layer are laminated by co-extrusion.

9. The surface protective film according to claim 3, wherein, the base material layer and the adhesion layer are laminated by co-extrusion.

10. The surface protective film according to claim 4, wherein, the base material layer and the adhesion layer are laminated by co-extrusion.

11. The surface protective film according to claim 6, wherein, the base material layer and the adhesion layer are laminated by co-extrusion.

12. The surface protective film according to claim 7, wherein, the base material layer and the adhesion layer are laminated by co-extrusion.
